(19) United States
(12) Patent Application Publication
(10) Pub. No.: US 2024/0351699 A1
(43) Pub. Date: Oct. 24, 2024

(54) ACOUSTIC PANEL FOR AN AIRCRAFT TURBOMACHINE

(71) Applicant: SAFRAN NACELLES, GONFREVILLE-L'ORCHER (FR)

(72) Inventors: Bertrand Léon Marie DESJOYEAUX, MOISSY-CRAMAYEL (FR); Mathieu François Eric PREAU, MOISSY-CRAMAYEL (FR); Marc VERSAEVEL, MOISSY-CRAMAYEL (FR); Pierre Charles CARUEL, MOISSY-CRAMAYEL (FR); Geneviève CLUZEAU, MOISSY-CRAMAYEL (FR)

(73) Assignee: SAFRAN NACELLES, GONFREVILLE-L'ORCHER (FR)

(21) Appl. No.: 18/637,871

(22) Filed: Apr. 17, 2024

(30) Foreign Application Priority Data
Apr. 20, 2023 (FR) 2303999

(51) Int. Cl. B64D 33/02

(52) U.S. Cl. CPC B64D 33/02; B64D 2033/0206

(57) ABSTRACT

An acoustic panel for an aircraft turbomachine has a sandwich structure. The sandwich structure includes a cell structure with a plurality of acoustic cells, a perforated acoustic structure, and a porous acoustic structure attached to the perforated acoustic structure. The perforated acoustic structure is arranged between the cell structure and the porous acoustic structure. The porous acoustic structure is multi-layered and has a first woven textile layer and a second woven textile layer connected to the first layer. The second layer is arranged between the first layer and the perforated acoustic structure.

### CROSS-REFERENCE TO RELATED APPLICATION

This application claims priority to French Patent Application No. FR 2303999, filed Apr. 20, 2023, the disclosure of which is hereby expressly incorporated by reference herein in its entirety.

### TECHNICAL FIELD

The disclosure relates to the field of acoustic panels for aircraft turbomachine. In particular, the disclosure relates to the field of acoustic panels with a sandwich structure.

### BACKGROUND

An aircraft turbomachine typically has a longitudinal axis. It comprises, for example, from upstream to downstream in the direction of gas flow along the longitudinal axis, a fan, a low-pressure compressor, a high-pressure compressor, a combustion chamber, a high-pressure turbine, a low-pressure turbine and a gas exhaust nozzle.

The fan sucks in a flow of air divided into a primary flow and a secondary flow. The primary flow passes through a primary duct in the turbomachine, while the secondary flow is directed towards a secondary duct surrounding the primary duct.

The primary flow is compressed in the compressors. The compressed air is then mixed with a fuel and burnt in the combustion chamber. The gases produced by combustion pass through the turbines and then escape through the nozzle, the cross-section of which allows these gases to be accelerated to generate propulsion.

The fan typically comprises a disc that can rotate about the longitudinal axis and blades mounted on the disc. The blades are surrounded by a fan casing centered on the longitudinal axis and designed to retain the blades in the event of damage, for example to the blades.

The fan casing is typically surrounded by a nacelle to protect the fan. A fan of this type is said to be ducted, as opposed to unducted fans whose blades are not surrounded by a casing.

The turbomachine also includes an intermediate casing located downstream of the fan casing. The intermediate casing typically comprises an annular inner shroud centered on the longitudinal axis and an annular outer shroud arranged coaxially around the inner shroud, the outer and inner shrouds being connected by radial arms. Together with the inner shroud, the outer shroud defines a portion of the secondary duct.

Turbomachine is a major source of noise pollution and there is a strong demand to reduce this type of pollution. To this end, it has been proposed to equip certain components of the turbomachine, such as the fan and intermediate casings and/or the nacelle, with acoustic panels in order to reduce the noise generated by the turbomachines.

An acoustic panel has a sandwich structure and typically comprises a cell structure comprising a plurality of acoustic cells forming Helmholtz resonators. The acoustic panel further comprises a perforated acoustic structure allowing sound waves to propagate through the core. Acoustic energy is dissipated by viscous effects in the perforated acoustic structure and the height of the core allows the attenuated frequency range to be adjusted. The acoustic panel may further comprise a porous acoustic structure such that the perforated acoustic structure is located between the cell structure and the porous acoustic structure. In this case, it is the porous structure that dissipates the majority of the acoustic energy. The porous acoustic structure typically has openings smaller than the diameter of the perforations in the perforated acoustic structure. The perforated acoustic structure is located inside the cell structure and is in contact with the secondary air flow. Interactions between the secondary air flow and the perforations tend to generate turbulence that favors aerodynamic drag, thus reducing the aerodynamic performance of the turbomachine. The porous acoustic structure enables to reduce these interactions with the secondary air flow while absorbing sound waves. However, this solution presents a number of challenges, not least the assembly of the acoustic panel. Adding the porous acoustic structure requires, among other things, an additional assembly step for the porous acoustic structure.

To overcome this disadvantage, document WO-A1-2021/084206 proposes forming the cell structure and the perforated acoustic structure in a single piece and connecting this piece to the porous acoustic structure by entanglement of their respective materials, for example during a molding step of the acoustic panel. Such an acoustic panel thus has the advantage of being able to be manufactured in a single piece.

Although this solution has many advantages, it is not entirely satisfactory. The porous acoustic structure is generally thin so as not to penalize the mass of the acoustic panel.

However, the thinner the porous acoustic structure, the more difficult it is to ensure cohesion between the porous acoustic structure and the assembly formed by the cell structure and the perforated acoustic structure. As the mechanical strength of such an acoustic panel is low, it is difficult to guarantee the integrity of the acoustic panel.

There is therefore a need to improve the mechanical strength of acoustic panels for aircraft turbomachine, while minimizing the impact on the aerodynamic performance of the turbomachine.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

To this end, the disclosure proposes an acoustic panel for an aircraft turbomachine, the acoustic panel having a sandwich structure comprising:
a cell structure comprising a plurality of acoustic cells,
a perforated acoustic structure, and
a porous acoustic structure attached to the perforated acoustic structure, the perforated acoustic structure being arranged between the cell structure and the porous acoustic structure.

The acoustic panel is remarkable in that the porous acoustic structure is multi-layered and comprises:
a first woven textile layer, and
a second woven textile layer connected to the first layer, the second layer being arranged between the first layer and the perforated acoustic structure,
the first and second layers each comprising yarns having different first and second diameters respectively, the first diameter being smaller than the second diameter.

According to the disclosure, the porous acoustic structure is multi-layered and comprises first and second woven textile layers.

The woven textile layers ensure the porosity of the structure and therefore the penetration of acoustic waves into the cell structure.

In addition, the second woven textile layer provides the connection between the perforated acoustic structure and the porous acoustic structure, while the first woven textile layer masks the second woven textile layer to minimize disturbance to the air flow in the turbomachine and guarantee the aerodynamic performance of the turbomachine.

Thanks to the combination of these two layers, the mechanical strength of the acoustic panel is improved. The impact on the aerodynamic performance of the turbomachine is also minimized.

Finally, the combination of these two textile layers enables to increase the thickness of the porous acoustic structure, which makes it easier to handle and assemble.

The disclosure may include one or more of the following features, taken in isolation from one another or in combination with one another:
the first diameter of each of the yarns of the first layer is between 0.01 mm and 0.2 mm, in particular between 0.01 mm and 0.15 mm,
the second diameter of each of the yarns of the second layer is between 0.01 mm and 1 mm, in particular between 0.03 mm and 0.5 mm,
the porous acoustic structure comprises binding yarns that intersect yarns of the first and second layers to bind the first and second layers together,
the yarns of the second layer comprise weft yarns and at least one warp yarn, at least two of the weft yarns forming the binding yarns,
the binding yarns have a diameter smaller than the yarn diameter(s) of the first and second layers, the first and second layers are connected by welding or gluing,
the first and second layers have first and second openings respectively, the first openings being smaller than the second openings,
the second openings have a size of between 0.1 mm and 2 mm, preferably between 0.1 mm and 1 mm,
the first layer has a roughness Ra of less than 20 μm, advantageously less than 10 μm, preferably less than 5 μm,
the porous acoustic structure is attached to the perforated acoustic structure by entanglement of the second layer in the perforated acoustic structure,
the first and second layers comprise a polymeric, metallic or ceramic material,
the first layer has a first thickness (e1) of between 0.1 mm and 0.5 mm and/or the second layer has a second thickness of between 0.3 mm and 1.5 mm,
the first layer has a weave in a satin pattern.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic representation in longitudinal section of an aircraft half-turbomachine,

FIG. 2 is a perspective view of an acoustic panel according to the disclosure,

FIG. 3 is a schematic cross-sectional view of the porous acoustic structure fitted to the acoustic panel in FIG. 2,

FIG. 4 is a schematic representation of the first layer of the porous acoustic structure in FIG. 3,

FIG. 5 is a schematic representation of the second layer of the porous acoustic structure in FIG. 3,

FIG. 6 is a perspective view of the porous acoustic layer in which the first and second layers are connected according to a first embodiment of the disclosure,

FIG. 7 is a cross-sectional view in a plane parallel to the direction X, of the porous acoustic structure in which the first and second layers are connected according to another embodiment of the disclosure,

FIG. 8 is a perspective view of part of the porous acoustic layer connected to the perforated acoustic structure.

### DETAILED DESCRIPTION

While illustrative embodiments have been illustrated and described, it will be appreciated that various changes can be made therein without departing from the spirit and scope of the invention.

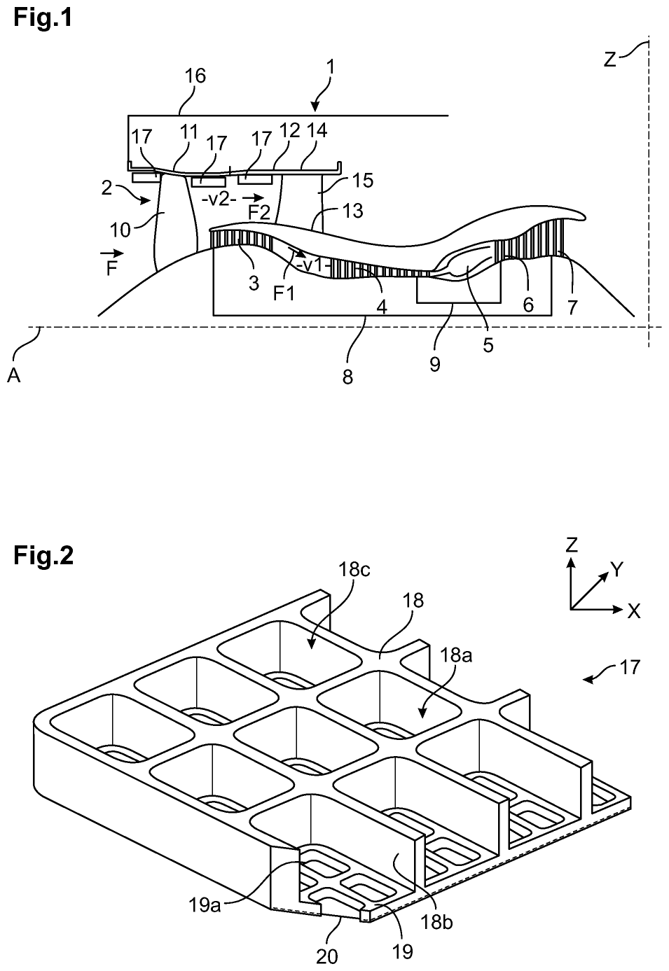

An example of a turbomachine 1 for an aircraft is shown in FIG. 1. The turbomachine 1 extends around and along a longitudinal axis A.

In the present application, the terms “upstream” and “downstream” are defined in relation to the direction of gas flow in the turbomachine 1 along the longitudinal axis A.

The terms “axial”, “axially”, “radial” and “radially” are defined with respect to the longitudinal axis A.

The terms “internal”, “internal”, “internally”, “external”, “external”, “externally” are defined in relation to the distance from the longitudinal axis A along an axis Z perpendicular to the longitudinal axis A.

The turbomachine 1 is preferably a turbojet engine, for example a dual flow and two-spool turbofan engine. It comprises, from upstream to downstream, a fan 2, at least one compressor such as a low-pressure compressor 3 and a high-pressure compressor 4, a combustion chamber 5, at least one turbine such as a high-pressure turbine 6 and a low-pressure turbine 7, and a gas exhaust nozzle.

The low and high pressure compressors 3, 4 and the high and low pressure turbines 6, 7 each comprise at least one rotor. The rotor of the low-pressure compressor 3 is connected to the rotor of the low-pressure turbine 7 by a low-pressure shaft 8 and the rotor of the high-pressure compressor 4 is connected to the rotor of the high-pressure turbine 6 by a high-pressure shaft 9. The high-pressure shaft 9 is arranged coaxially around the low-pressure shaft 8. The low and high pressure shafts 8, 9 are centered on the longitudinal axis A.

The fan 2 comprises a disc rotatable about the longitudinal axis A and blades 10 extending radially from the disc. The fan 2 also comprises a fan shaft (not shown) connected to the low-pressure shaft 8 via a speed reducer, for example.

The fan 2 sucks in an air flow F divided into a primary air flow F1 and a secondary air flow F2. The primary air flow F1 passes through a primary duct v1 of the turbomachine 1 and the secondary air flow F2 flows into a secondary duct v2 of the turbomachine 1. The secondary duct v2 surrounds the primary duct v1.

The primary flow F1 is compressed in the low-pressure compressor 3 and then in the high-pressure compressor 4. The compressed air is then mixed with a fuel and burnt in the combustion chamber 5. The gases formed by the combustion pass through the high-pressure and low-pressure turbines 6, 7, and finally escape through the nozzle, the cross-section of which allows the gases to be accelerated to generate propulsion.

The fan 2 is of the ducted type. The turbomachine 1 also includes a fan casing 11. The fan casing 11 is annular and centered on the longitudinal axis A. It is arranged around the blades 10. The fan casing 11 forms a portion of the secondary duct v2.

The turbomachine 1 also comprises an intermediate casing 12. The intermediate casing 12 is arranged downstream of the fan casing 11 and is connected to the fan casing 11 by flanges, for example.

The intermediate casing 12 is centered on the longitudinal axis A and comprises an inner shroud 13 and an outer shroud 14 connected by arms 15. The outer shroud 14 is annular and centered on the longitudinal axis A. It is arranged coaxially around the inner shroud 13. Together with the inner shroud 13, the outer shroud 14 delimits a portion of the secondary duct v2.

The turbomachine 1 also comprises a nacelle 16. The nacelle 16 is arranged around the fan and intermediate casings 11, 12.

In order to reduce the noise pollution generated by the turbomachine 1, the turbomachine 1 comprises at least one and advantageously several acoustic panels 17. Each acoustic panel 17 is advantageously able to absorb acoustic energy over a frequency range of between 300 Hz and 3000 Hz.

Each acoustic panel 17 extends over an angular sector or has an annular shape centered on the longitudinal axis A. Each acoustic panel 17 can be mounted and attached inside the fan casing 11 and/or inside the outer shroud 14 of the intermediate casing 12 and/or inside the nacelle 16.

With reference to FIG. 2, each acoustic panel 17 has a sandwich structure. Each acoustic panel 17 comprises a cell structure 18, a perforated acoustic structure 19 and a porous acoustic structure 20. The perforated acoustic structure 19 is located between the cell structure 18 and the porous acoustic structure 20. When the acoustic panel 17 is mounted in the turbomachine 1, the porous acoustic structure 20 faces the air duct in which the acoustic waves propagate, and the cell structure 18 is located towards the nacelle support structure, in the opposite direction to the air duct.

The cell structure 18 comprises acoustic cells 18a. The acoustic cells 18a form Helmholtz resonators. The acoustic cells 18a are delimited from one another by peripheral walls 18b. Each acoustic cell 18 has a polygonal cross-section, for example square, rectangular or hexagonal. The cross-section of the acoustic cells 18a may differ from one acoustic cell 18a to another. Each acoustic cell 18 is hollow and has an internal cavity 18c. The internal cavities 18c are delimited by the peripheral walls 18b.

The peripheral walls 18b extend from the perforated acoustic structure 19.

The cell structure 18 may also include additional elements such as fastening systems or any other feature.

Advantageously, the cell structure 18 has a thickness of between 1 mm and 5 mm, particularly between 1 mm and 3 mm.

The cell structure 18 comprises, for example, a metallic material such as aluminum, in particular an aluminum alloy chosen from the 6000 series, or a polymeric material chosen, for example, from thermoplastics or composites.

The perforated acoustic structure 19 is located between the porous acoustic structure 20 and the cell structure 18. The perforated acoustic structure 19 comprises perforations 19a. Preferably, the perforations 19a are regularly distributed in the perforated acoustic structure 19. The perforations 19a communicate with the cavities 18c of the acoustic cells 18a. Preferably, a group of four perforations 19a communicate with a cavity 18c of an acoustic cell 18a. The perforations 19a have, for example, a substantially polygonal cross-section, for example square and/or rectangular and/or hexagonal and/or circular. The perforations 19a have a dimension greater than or equal to 1 mm, for example, and in particular greater than or equal to 2 mm.

Advantageously, the perforated acoustic structure 19 has a thickness less than the thickness of the cell structure 18. The thickness of the perforated acoustic structure 19 is preferably between 0.5 mm and 3 mm.

The perforated acoustic structure 19 comprises a material that is identical to or different from the material of the cell structure 18.

In an advantageous embodiment, the perforated acoustic structure 19 and the cell structure 18 form a monolithic part.

According to the disclosure, the porous acoustic structure 20 is multi-layered and is in the form of a lattice or mesh.

Advantageously, the porous acoustic structure 20 has a mass per unit area of between 40 gsm and 1500 gsm, in particular between 100 gsm and 1100 gsm.

Advantageously, the porous acoustic structure 20 has a thickness e of between 0.5 mm and 2 mm.

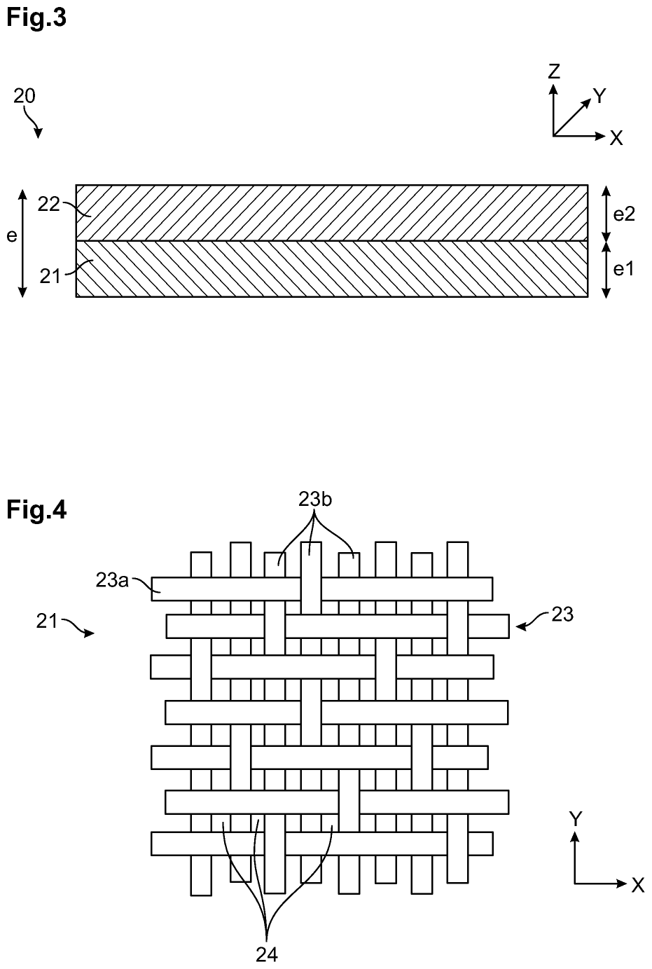

With reference to FIG. 3, the porous acoustic structure 20 comprises a first layer 21 and a second layer 22.

The first layer 21 is arranged inside the second layer 22. Advantageously, the first layer 21 is the innermost layer of the acoustic panel 17 when mounted in the turbomachine 1. Thus, the first layer 21 is in contact with the secondary air flow F2.

Advantageously, the first layer 21 has a first thickness e1 of between 0.1 mm and 0.5 mm.

The first layer 21 is a woven textile layer. With reference to FIG. 4, the first layer 21 comprises yarns 23. Each yarn 23 comprises an assembly of fibers or filaments.

Each yarn 23 advantageously comprises a polymeric material chosen, for example, from thermoplastics. The thermoplastic material is, for example, chosen from polyaryletherketones (PAEK) such as polyetherketone (PEK), polyetheretherketone (PEEK) or polyetherketoneketone (or PEKK) or polyacrylonitrile (PAN) fibers such as HEXTOW® AS4, AS7 or IM7 fibers marketed by Hexcel. In another example, the yarns 23 comprise a metallic material such as aluminum or a ceramic material.

The yarns 23 have a first diameter of, for example, between 0.01 mm and 0.2 mm, in particular between 0.01 mm and 0.15 mm.

The yarns 23 of the first layer 21 are advantageously organized into a plurality of plies 23′ of yarns 23 superimposed along the radial axis Z to form the first thickness e1 of the first layer 21. FIG. 4 illustrates a single ply 23′ of yarns 23.

The yarns 23 are woven. The yarns 23 are organized into at least one or more weft yarns 23a extending in a first direction X and at least one or more warp yarns 23b extending in a second direction Y perpendicular to the first direction X. The weft yarns 23a and warp yarns 23b intersect. Preferably, the weft yarns 23a and warp yarns 23b intersect in a satin pattern. The weave ratio of the satin pattern is, for example, 4, 5 or 8. In the first direction X, a weft yarn 23a successively overlaps a plurality, in particular at least two, three or even four warp yarns 23b, then passes under a warp yarn 23b and successively overlaps a plurality, in particular at least two, three or even four warp yarns 23b. “Overlapping” is understood to mean the passage of a first yarn over a second yarn extending perpendicular to the first yarn.

Weaving according to the satin pattern offers the advantage of minimizing the roughness of the first layer 21. Preferably, the first layer 21 has a roughness Ra of less than 20 μm, advantageously less than 10 μm, preferably less than 5 μm. Thanks to this roughness, the flow of the secondary air flow F2 is only slightly disturbed and the aerodynamic performance of the turbomachine 1 is improved.

The first layer 21 also comprises first openings 24. The first openings 24 are located between the yarns 23. Advantageously, the first openings 24 have different sizes so that the acoustic impedance of the first layer 21 varies in the X and Y directions.

The first layer 21 thus preferably has an acoustic resistance of between 15 Rayls cgs and 120 Rayls cgs.

The second layer 22 is arranged between the first layer 21 and the perforated acoustic structure 19. Advantageously, the second layer 22 has a second thickness e2 of between 0.3 mm and 1.5 mm.

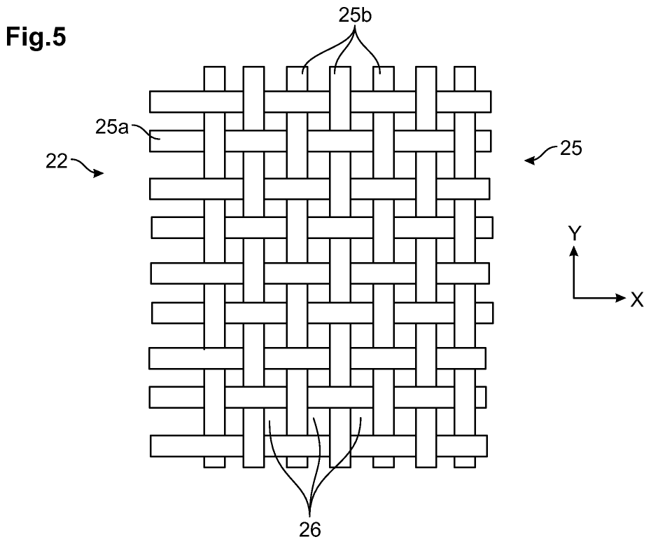

According to the disclosure, the second layer 22 is a woven textile layer. With reference to FIG. 5, the second layer 22 comprises yarns 25. Each yarn 25 may comprise an assembly of fibers or filaments.

Advantageously, the yarns 25 comprise a polymeric material chosen, for example, from thermoplastics. The thermoplastic material is, for example, chosen from polyaryletherketones (PAEK) such as polyetherketone (PEK), polyetheretherketone (PEEK) or polyetherketoneketone (or PEKK) or polyacrylonitrile (PAN) fibers such as HEXTOW® AS4, AS7 or IM7 fibers marketed by Hexcel. In another example, the yarns 25 comprise a metallic material such as aluminum or a ceramic material. In a preferred embodiment, the material of the yarns 25 of the second layer 22 is identical to the material of the yarns 23 of the first layer 21.

The yarns 25 of the second layer 22 are organized into a plurality of plies 25′ of yarns 25 superimposed along the radial axis Z to form the second thickness e2 of the second layer 22. FIG. 5 illustrates a single sheet 25′ of yarns 25.

The yarns 25 are woven. They comprise one or more weft yarns 25a extending in the first direction X and one or more warp yarns 25b extending in the second direction Y. The weft yarns 25a and warp yarns 25b intersect.

The weft yarns 23a and warp yarns 23b intersect, for example in a satin, twill or canvas pattern.

The yarns 25 of the second layer 22 advantageously have a second diameter greater than the first diameter of the yarns 23 of the first layer 21. The second diameter is for example between 0.01 mm and 1 mm, in particular between 0.03 mm and 0.5 mm.

According to another example, the weft yarns 25a have a diameter less than or equal to the diameter of the yarns 23 of the first layer 21 and the warp yarns 25b of the second layer 22 have a diameter greater than the diameter of the weft yarns 25a of the second layer 22. The diameter of the warp yarns 25b is for example between 0.01 mm and 2 mm, in particular between 0.03 mm and 1 mm.

The second layer 22 also comprises second openings 26. The second openings 26 are located between the yarns 25. Advantageously, the second openings 26 are larger in size than the first openings 24. Preferably, the size of the second openings 26 is between 0.1 mm and 2 mm, in particular between 0.1 mm and 1 mm.

The second layer 22 thus preferably has an acoustic resistance of between 15 rayls cgs and 120 rayls cgs.

In a first embodiment, the first and second layers 21, 22 are connected together by weaving.

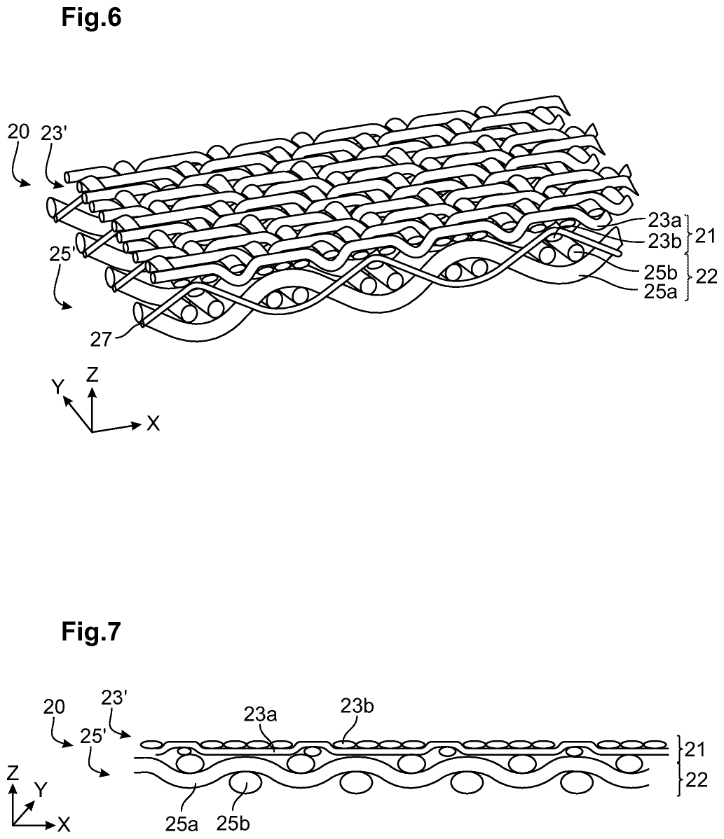

With reference to FIG. 6, the first and second layers 21, 22 are connected together by weaving, in an interlock pattern. According to this embodiment, the porous layer 20 also comprises binding yarns 27 which intersect the yarns 23, 25 of the first and second layers 21, 22. Advantageously, the binding yarns 27 have a third diameter smaller than the second diameter of the yarns 25 of the second layer 22. Advantageously, the third diameter is less than or equal to the first diameter of the yarns 23 of the first layer 21. This feature reduces the roughness Ra of the first layer 21.

According to one example, the binding yarns 27 consist of weft yarns 25a of the second layer 22 having a diameter less than or equal to the yarns 23 of the first layer 21. This feature reduces the roughness Ra of the first layer 21.

According to another example illustrated in FIG. 6, the binding yarns 27 are additional yarns, and therefore distinct from the yarns 23, 25 of the first and second layers 21, 22.

Each additional yarn advantageously comprises a polymeric material chosen, for example, from thermoplastics. The thermoplastic material is, for example, chosen from polyaryletherketones (PAEK) such as polyetherketone (PEK), polyetheretherketone (PEEK) or polyetherketoneketone (or PEKK) or polyacrylonitrile (PAN) fibers such as HEXTOW® AS4, AS7 or IM7 fibers marketed by Hexcel. In another example, the additional yarns comprise a metallic material such as aluminum or a ceramic material.

The binding yarns 27 pass successively and periodically through the first layer 21 and the second layer 22. The first and second layers 21, 22 thus form a single woven assembly. The binding yarns 27 therefore cause even less disruption to the weaving of the first layer 21.

According to the example in FIG. 6, the first layer 21 is woven in a satin pattern with a weave ratio of 4. Each weft yarn 23a passes successively over three warp yarns 23b and then under a warp yarn 23b.

The second layer 22 is woven in a plain pattern with a weave ratio of 2 to 1. Each weft yarn 25a passes successively over two warp yarns 25b and then under two warp yarns 25b, and each warp yarn 25b passes alternately over and under a weft yarn 25a.

According to this example, the binding yarns 27 extend along the first direction X and pass successively over a warp yarn 23b of the first layer 21 and under two warp yarns 25b of the second layer 22.

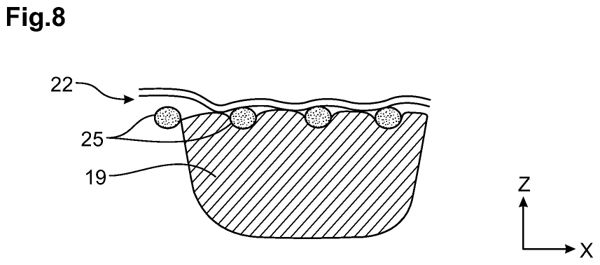

In another embodiment illustrated in FIG. 7, the first and second layers 21, 22 are connected together by gluing or welding. According to this embodiment, a layer of adhesive is arranged between the first and second layers 21, 22. The layer of adhesive may be continuous or discontinuous, i.e. a number of points of adhesive are arranged between the first and second layers 21, 22.

According to the particular example shown in FIG. 7, the first layer 21 is woven in a satin pattern with a weave ratio of 5. The second layer 22 is woven in a plain pattern with a weave ratio of 1.

The first and second layers 21, 22 are connected by welding or by gluing via adhesive dots.

In yet other embodiments, the first and second layers 21, 22 are connected together by calendering, thermocompression, fusing, stitching, tufting or any other method of joining woven textile layers.

The porous acoustic structure 20 is attached to the perforated acoustic structure 19. With reference to FIG. 8, the porous acoustic structure 20 is preferably attached to the perforated acoustic structure 19 by entanglement of the second layer 22 in the perforated acoustic structure 19.

By entanglement is meant an at least partial embedding of the yarns 25 of the second layer 22 in the material of the perforated acoustic structure 19. The yarns 25 of the second layer 22 are thus arranged at least partially in the thickness e2 of the perforated acoustic structure 19.

Thanks to the combination of the first and second layers 21, 22 according to the disclosure, the mechanical strength of the acoustic panel 17 is improved. In particular, it can be seen during peel tests that the acoustic panel 17 breaks within the porous acoustic layer 20 and not between the porous acoustic layer 20 and the perforated acoustic structure 19.

In addition, the combination of the first and second layers 21, 22 gives the acoustic panel 17 sufficient stiffness to reduce the thickness of the perforated acoustic layer 19, making it possible to reduce the mass of the acoustic panel 17 by 35%.

The first layer 21 also enables to reduce disturbances to the flow of the secondary air flow F2, thus improving the aerodynamic performance of the turbomachine 1.

1. An acoustic panel for an aircraft turbomachine, the acoustic panel having a sandwich structure comprising:
a cell structure comprising a plurality of acoustic cells,
a perforated acoustic structure, and
a porous acoustic structure attached to the perforated acoustic structure, the perforated acoustic structure being arranged between the cell structure and the porous acoustic structure, wherein the porous acoustic structure is multi-layered and comprises:
a first woven textile layer, and
a second woven textile layer connected to the first layer, the second layer being arranged between the first layer and the perforated acoustic structure, the first and second layers each comprising yarns having different first and second diameters, respectively, the first diameter being smaller than the second diameter.

2. The acoustic panel according to claim 1, wherein the first diameter of each of the yarns of the first layer is between 0.01 mm and 0.2 mm.

3. The acoustic panel according to claim 2, wherein the first diameter of each of the yarns of the first layer is between 0.01 mm and 0.15 mm.

4. The acoustic panel according to claim 1, wherein the second diameter of each of the yarns of the second layer is between 0.01 mm and 1 mm.

5. The acoustic panel according to claim 4, wherein the second diameter of each of the yarns of the second layer is between 0.03 mm and 0.5 mm.

6. The acoustic panel according to claim 1, wherein the porous acoustic structure comprises binding yarns which intersect yarns of the first and second layers to bind the first and second layers together.

7. The acoustic panel according to claim 2, wherein the second diameter of each of the yarns of the second layer is between 0.01 mm and 1 mm, and the yarns of the second layer comprise weft yarns and at least one warp yarn, at least two of the weft yarns forming the binding yarns.

8. The acoustic panel according to claim 7, wherein the binding yarns have a diameter smaller than the diameter(s) of yarns of the first and second layers.

9. The acoustic panel according to claim 1, wherein the first and second layers are connected by welding or gluing.

10. The acoustic panel according to claim 1, wherein the first and second layers have first and second openings respectively, the first openings being smaller than the second openings.

11. The acoustic panel according to claim 10, wherein the second openings have a size of between 0.1 mm and 2 mm.

12. The acoustic panel according to claim 11, wherein the second openings have a size of between 0.1 mm and 1 mm.

13. The acoustic panel according to claim 1, wherein the first layer has a roughness Ra of less than 20 μm.

14. The acoustic panel according to claim 13, wherein the first layer has a roughness Ra of less than 10 μm.

15. The acoustic panel according to claim 14, wherein the first layer has a roughness Ra of less than 5 μm.

16. The acoustic panel according to claim 1, wherein the porous acoustic structure is attached to the perforated acoustic structure by entanglement of the second layer in the perforated acoustic structure.

17. The acoustic panel according to claim 1, wherein the first and second layers comprise a polymeric, metallic or ceramic material.

18. The acoustic panel according to claim 1, wherein the first layer has a first thickness (e1) of between 0.1 mm and 0.5 mm and/or the second layer has a second thickness (e2) of between 0.3 mm and 1.5 mm.

19. The acoustic panel according to claim 1, wherein the first layer has a weave in a satin pattern.
